(19) United States
(12) Patent Application Publication
(10) Pub. No.: US 2008/0195460 A1
(43) Pub. Date: Aug. 14, 2008

(54) Attention Marketplace with Individualized Advertisements

(76) Inventor: Kivin Varghese, Clayton, NC (US)

Correspondence Address: PATENTBEST, 4600 ADELINE ST., #101, EMERYVILLE, CA, 94608, US

(21) Appl. No.: 11/674,788

(22) Filed: Feb. 14, 2007

(51) Int. Cl. G06F 17/30; G06Q 30/00

(52) U.S. Cl. 705/10; 705/14

(57) ABSTRACT

Disclosed are methods in which a user is compensated for viewing advertisements. A user expresses interest in viewing a particular advertisement, but the variant of that advertisement that the user views is based on the user's demographic, psychographic, or behavioral traits. Thus, two different users with different traits who express interest in viewing the same advertisement may view different variants of that advertisement tailored to their individual traits. Rules specifying which users view which advertisement variants may be re-defined while an advertising campaign is underway in order to increase the effectiveness of an advertising campaign.

### BACKGROUND OF THE INVENTION

1. Field of the Invention

The invention relates to methods for advertising, and in particular, to methods for advertising in which the consumer is compensated for his or her attention.

2. Description of Related Art

For many years, the advertising industry has relied on a combination of different types of advertisements, including display advertisements, audio, video, and interactive commercials. Those forms of advertisements have come to pervade popular entertainment, from print media to radio, television, movies, and the World Wide Web. However, as advertisements have become more pervasive, consumer attention to advertisements has waned.

Unfortunately, the problem of waning attention continues to grow because of advances in technology and changes in entertainment forms and habits. Digital video recorders, for example, make it ever easier to skip or fast-forward through advertisements, and a plethora of cable and satellite entertainment programming appears to have fragmented audiences and decreased the average consumer's attention span.

In the last several years, there have been some notable attempts to create a paradigm shift in the advertising industry by paying consumers for their attention—giving some amount of compensation in exchange for a consumer watching, listening to, or otherwise being exposed to an advertisement. U.S. Patent Application Publication No. 2004/0133468 (application Ser. No. 10/474,242), which is the work of the present inventor, describes such a system in which users establish an account with an advertisement provider, are given a list of advertisements to watch, and are compensated for watching and answering questions on those advertisements. That application is incorporated by reference herein in its entirety.

U.S. Pat. No. 6,529,878 discloses a variation on the pay-for-attention model in which users are asked to log into a service and are presented with a number of interactive surveys, in which the next question in the survey depends, to some extent, on the user's answer to the last question in the survey. New, text-based World Wide Web pages are generated with new questions as the user answers the previous questions.

Pay-for-attention systems may increase the accountability and efficacy of conventional advertising, insofar as the advertiser knows exactly who is watching its advertisements and, to some extent, whether or not the brand message was absorbed. However, another fundamental problem of advertising remains: exposing the right consumer to the right advertisement at the right time so as to influence buying behavior.

### SUMMARY OF THE INVENTION

One aspect of the invention relates to a method of advertising. The method comprises establishing one or more of the user's demographic, psychographic, or behavioral traits and allowing a user to indicate an interest in viewing an advertisement. The method further comprises selecting among several versions of the advertisement based on the established demographic, psychographic, or behavioral traits, presenting the selected version of the advertisement to the user, and compensating the user.

Another aspect of the invention relates to a method of conducting an advertising campaign. The method comprises establishing one or more demographic, psychographic, or behavioral traits for each of a plurality of users, and associating particular demographic, psychographic, or behavioral traits with particular variants of an advertisement. The method also comprises allowing each of the plurality of users to indicate an interest in viewing the advertisement. For each of the plurality of users, the method comprises presenting the advertisement variant that is associated with the particular demographic, psychographic, or behavioral traits of the user and compensating at least some of the plurality of users. Additionally, the method comprises gauging the response of the plurality of users to their respective advertisement variants and altering the association of particular advertisement variants with particular demographic, psychographic, or behavioral traits based on the response in order to increase the effectiveness of the advertising campaign.

Yet another aspect of the invention relates to an advertising system. The system comprises a marketplace module, a delivery module, and a compensation module. The marketplace module is adapted to accept data on one or more users, associate user demographic, psychographic, or behavioral traits with ones of a plurality of variants of an advertisement, and select a particular advertisement variant for a particular user based on the user demographic, psychographic, or behavioral variants. The delivery module is adapted to transmit the particular advertisement variant to the particular user. The compensation module is adapted to compensate the user for viewing the particular advertisement variant.

Other aspects, features, and advantages of the invention will be set forth in the description that follows.

### BRIEF DESCRIPTION OF THE DRAWINGS

The invention will be described with respect to the following drawing figures, in which like numerals represent like elements throughout the figures, and in which:

FIG. 1 is a general flow diagram illustrating the tasks involved in a method according to one embodiment of the invention;

FIG. 2 is an illustration of an exemplary advertisement selection screen for use in the method of FIG. 1;

FIG. 3 is an illustration of an exemplary direct response screen for use in the method of FIG. 1;

FIG. 4 is a flow diagram of certain specific tasks of the method of FIG. 1;

FIG. 5 is a method of obtaining user brand and buying habits and using that information to target advertisements and provide product information;

FIG. 6 is an illustration of an exemplary basic screen for use in the method of FIG. 5;

FIG. 7 is an illustration of an exemplary comparison shopping screen for use in the method of FIG. 5;

FIG. 8 is an illustration of a customized shopping list screen for use in the method of FIG. 5;

FIG. 9 is an illustration of an exemplary user communication sent in the course of the method of FIG. 5;

FIG. 10 is an illustration of a system that may be used in the execution of methods according to embodiments of the present invention;

FIG. 11 is an illustration of a personal computing device in use executing some of the tasks of the method of FIG. 5; and

FIG. 12 is an illustration of a system with a portable personal computing device that may be used in embodiments of the present invention.

### DETAILED DESCRIPTION

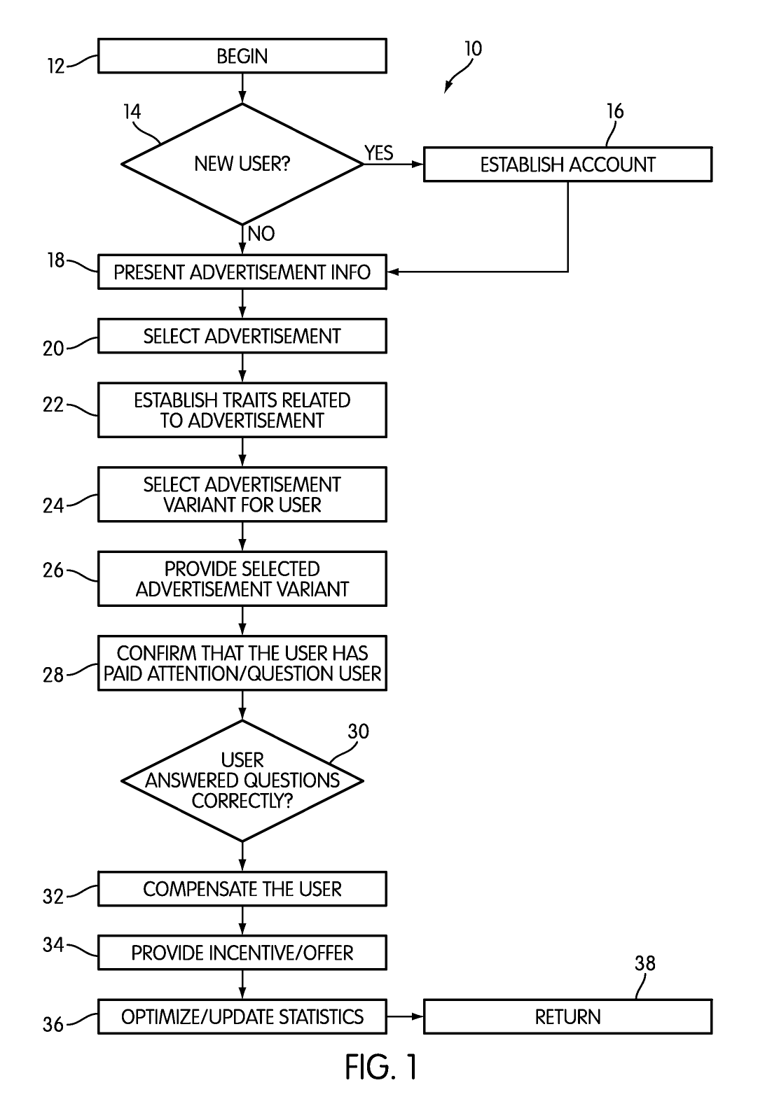

FIG. 1 is a flow diagram of a method, generally indicated at 10, for providing a user with a customized advertisement in a pay-for-attention advertising service. In a pay-for-attention advertising service, also called an attention marketplace, users are directly compensated for viewing advertisements, and for performing other tasks that require their thought and attention.

Method 10 may be performed in a variety of ways, with or without the use of automated electronic systems to manage its tasks. Specific embodiments of systems that may be used to carry out method 10 will be described below in more detail. Some of the description of method 10 presented below may assume that decisions regarding method 10 are made by an automated system or systems, and that a user interfaces with the automated system or systems using a personal computing device connected to the automated system through a computing network, such as the Internet. Method 10 is particularly well suited for execution using the World Wide Web of the Internet.

The personal computing device used by the user may be any device capable of performing the functions attributed to it in this specification. Examples of personal computing devices include desktop and laptop personal computers, personal digital assistants (PDAs), cellular telephones, digital music and media players, so-called “smart” phones that combine cellular telephone and PDA functionality, televisions, and television set-top boxes.

Method 10 begins at 12 when a user uses a personal computing device to connect with the compensation coordinator that operates method 10. The method then continues with task 14, a decision task. In task 14, if the user seeking to participate in method 10 is a new user (task 14:YES), method 10 continues with task 16, in which the user is asked to establish a new account.

When establishing an account in task 16, a user may be asked for a variety of different types of information. Generally, the information collected in order to establish a new account may be any combination of basic contact information, demographic information, psychographic information, and behavioral information. Demographic information includes location and vital statistics. Psychographic information refers to information that tends to indicate the social class and lifestyle of a user. Behavioral information refers to information on specific behaviors, such as spending, shopping, visiting, and/or website browsing behaviors and activity. The user might be asked any number of questions that the operator of method 10 desires; however, the number of questions asked of the new user and the range of information collected at the outset would generally be balanced against the possibility of alienating the user and driving him or her away. Some questions that the user is asked when establishing a new account may be designated as “required” while other questions may be designated as “optional.” As will be described in more detail below, information about the user may also be obtained from other sources as well and combined with information obtained from the user.

In some embodiments, users may be screened at the outset based on their contact information. For example, users may only be permitted to register and establish a new account in task 16 if they live in a particular place, have an e-mail address from a particular domain, such as the “.edu” domain, have a cellphone number, or are able to verify their identity or personal characteristics (e.g., gender and age) in some other way. Certain other conventional technologies may also be used to screen users at the outset. For example, a user could be asked to take a CAPTCHA™ (Completely Automated Public Turing Test to Tell Computers and Humans Apart) to confirm that the user is a real person. Users might also be asked to agree to terms of service or a privacy policy.

Once a user account has been established in task 16, method 10 continues with task 18, in which the user is presented with information on available advertisements. Whether or not an advertisement is “available” for viewing by a particular user depends on such factors as whether the user in question has already seen and been compensated for viewing the advertisement and whether the advertisement is appropriate for the user. The appropriateness of any particular advertisement is generally determined by considering whether or not the advertiser is targeting consumers like the user for that particular advertisement. For example, in most situations, it may not be the best use of a marketer's budget to pay for a male to watch an advertisement for feminine hygiene products (yet that exact situation often arises in conventional television, print, and even interactive mediums where targeting is inexact).

Appropriateness of any particular advertisement for any particular user may also be determined using more sophisticated criteria. For example, it may be determined that certain advertisements will only be offered to men, ages 18-34. Additionally, any of the available information about the user (e.g., acquired from questions asked of the user during the sign-up process or added to the user's profile at some other point) could be used to determine whether or not a particular advertisement is appropriate. As another example, it could be determined that a user is to be offered an advertisement for a product that competes with one which he or she already uses, if the appropriate behavioral information already exists in the user's profile to establish his or her relevant brand and buying behaviors. Alternately, an advertisement could be presented only or largely to users who already use a company's product, so as to introduce the user to related products or new features of the existing product or to generally reinforce brand loyalty and identification. In effect, task 18 serves as a “first pass” customization of advertisement to user, and it may involve a number of decision tasks which are omitted from FIG. 1 for simplicity of illustration.

Some other factors may also influence which advertisements and how many advertisements are deemed appropriate for the user. For example, in some embodiments, it may be desirable to limit the number of advertisements that the user can view in any particular time period, so as to ensure that the messages of the individual advertisements are absorbed and retained. If such a restriction is in place, then the number of advertisements presented to the user may be limited.

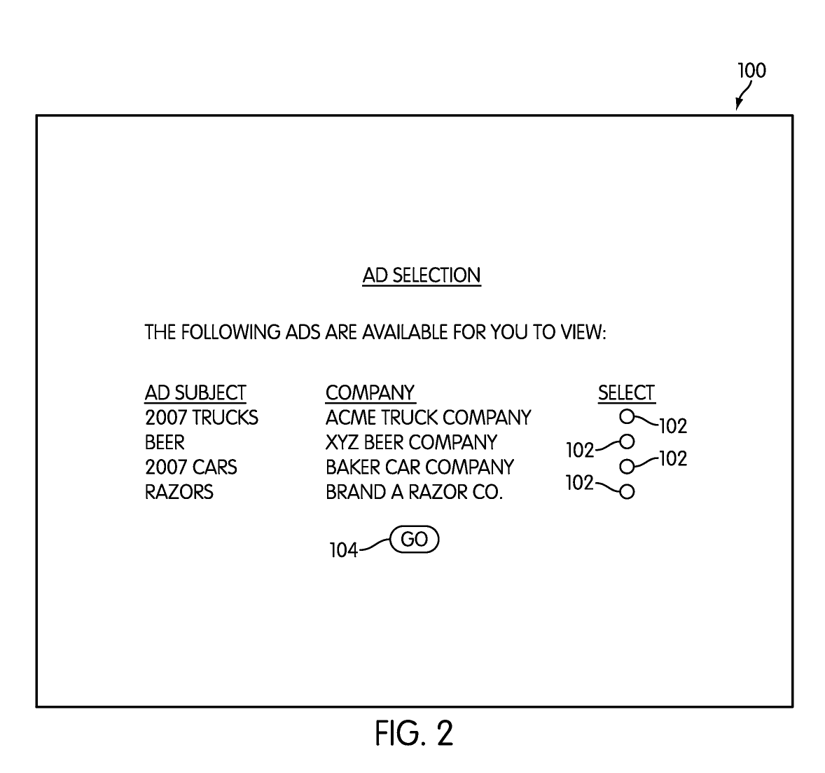

FIG. 2 is an illustration of an exemplary advertisement selection screen, generally indicated at 100. The advertisement selection screen 100 provides a list of available advertisements by subject and company, and provides a set of selection controls 102 and a button 104 that causes the selection to be processed. The selection controls 102 and other interactive elements of the list may vary from embodiment to embodiment.

On the selection screen 100, if a brand name is more closely associated with a certain product than the name of the company that produces the product, then the brand name may be listed instead of the company name. Generally speaking, the advertisement selection list 100 may present any desired information about the advertisements that are available, and may also omit any information about those advertisements that it may be desirable to omit. For example, it may not always be necessary or desirable to provide precise information about the product, brand, or sponsoring company in the advertisement list, because doing so may bias the user against watching a particular advertisement or may bias answers to questions posed prior to viewing the advertisement.

In some embodiments, it may be helpful to display certain other information in the advertisement list, such as the type of advertisement (video, audio, interactive, etc.) and the duration of the advertisement. Additionally, if the amount of compensation associated with a particular advertisement is a fixed quantity, it may be desirable to include the amount of compensation that a user could receive for viewing the advertisement on the advertisement selection list 100 in order to entice the user to view the advertisements.

In other embodiments, users may be permitted to choose an attention price or particular level of compensation in exchange for viewing an advertisement. Methods for allowing a user to select a particular attention price, and of selecting particular attention prices for the user, are disclosed in U.S. patent application Ser. No. 11/382,616, filed May 10, 2006, the contents of which are incorporated by reference herein in their entirety. The methods disclosed in that application may be used in method 10.

Generally speaking, when more than one advertisement is available for a particular user to view, any selection list 100 or other mechanism that allows the user to select a particular advertisement may be used in methods according to embodiments of the invention. However, there are circumstances in which it may not be necessary for a user to select an advertisement from an advertisement selection list 100. For example, if only one advertisement is currently available for a user to view, the user might be taken directly into viewing that advertisement.

Additionally, in some embodiments, a user might be drawn or directed into a method such as method 10 from an external source. For example, a user might click on a banner advertisement on a third-party website that indicates that the user could receive compensation for viewing an advertisement related to the banner. If the user were to do so, he or she might be taken directly into viewing the relevant advertisement, or directly to that relevant advertisement after establishing a new account in task 16. Methods for tagging advertisements and providing advertisements with compensation through broadcast and other media channels are disclosed in U.S. patent application Ser. No. 11/616,461, filed Dec. 27, 2006, the contents of which are incorporated by reference herein in their entirety. As described in that patent application, in some embodiments, a user need not overtly select an advertisement from among a list; rather, advertisements may be presented to the user in his or her normal course of media viewing.

In most embodiments, the advertisements with which the user is presented will be self-contained media presentations: video advertisements, audio advertisements, and interactive games, to give a few examples. Method 10 continues with task 20, in which a user selects an advertisement or (under certain circumstances) is taken to a particular advertisement.

In method 10, when a user selects an advertisement, he or she is not selecting a single, monolithic advertisement. Instead, he or she is electing to view one of a related family of advertisements. Which one of the family of advertisements a particular user views will depend on the particular traits of the user. Often, a user may not be aware that multiple versions of a particular advertisement exist. However, it is likely that different users with different traits selecting what appears to be the same advertisement to view will, in fact, see different versions of that advertisement.

Decisions regarding which user sees which version of an advertisement are generally not made at random, but are instead usually based on one or more of the user's traits, with particular advertisement variants being associated with particular user traits. Thus, method 10 continues with task 22, in which user traits relevant to the particular advertisement are established. A user's relevant traits or characteristics may be established in several ways. One of the easiest ways to establish user traits is to ask questions about those traits. In many embodiments, a user's existing brand loyalties and buying habits will determine which advertisement he or she is shown. For example, if the product to be advertised is razor brand A, the user may be asked in task 22 which brand of razor he or she uses. If the user is a user of brand B, the advertisement that he or she ultimately sees may explain why brand A is better than brand B. Conversely, if the user is already a user of brand A, he or she may be shown an advertisement for a new and related product by the same company.

However, questioning a user about his or her traits is not the only way to establish the user's traits. Users may use method 10 repeatedly to view multiple advertisements, and each time the user uses method 10, some information about the user is gathered, either in the initial profile created when the user initially establishes an account in task 16, or in responses to questions that the user is asked in the course of viewing other advertisements. Therefore, there may be situations in which the information used to determine which advertisement variant the user sees already exists in the user's profile. Continuing the above example, it may already be known that the user is male and a user of brand A razors, in which case task 22 may comprise searching the user's profile for information, rather than asking the user. In general, task 22 may include the task of searching for the desired information in the user's profile before asking the user questions about his or her behavior.

Although behavioral traits or characteristics, like brand buying behaviors, may determine which advertisement variant the user views in some embodiments, any demographic, psychographic, or behavioral trait may be questioned or used to establish which particular version of an advertisement a user ultimately views.

In some embodiments, a user's demographic, psychographic, or behavioral characteristics may not be obtained directly from the user. In today's society, user behaviors and characteristics are observed, recorded, and tracked in many settings, ranging from food and consumer goods buying behaviors to television watching preferences to Internet browsing habits. This information may be gathered in any way known in the relevant arts, and may be purchased or otherwise obtained by the operator of method 10 from the party or parties who gathered it for use in methods according to embodiments of the invention.

There are also some circumstances in which the brand usage behaviors of the user might become known to the operator of method 10 in the normal course of the method. For example, if a user participates in method 10 using his or her PDA through a particular wireless network, that network and, often, the type of PDA used, may be revealed to the operator of method 10 and used appropriately.

Method 10 continues with task 24, in which a particular advertisement variant is selected for the user, based on the traits established in task 22. To continue the razor example begun above, assume that the advertiser is advertising razors of a particular brand. There can be any number of advertisement variants. Table 1 lists a few of the possible advertisement variants for different types of users:

TABLE 1
Advertisement-variants for a single advertisement for brand A razors.

| | | Description/Advertising |
|---|---|---|
| Number | Target Users | Message |
| 1 | Male users of brand A razors. | Description of the new brand A+ |
| | | upgraded razor. |
| 2 | Male users of brand X or Y | Advantages of brand A/A+ over |
| | razors. | brands X and Y for men. |
| 3 | Male users without a buying | Generic introduction/description |
| | preference. | of brand A/A+ razors for men. |
| 4 | Female users of brand A | Description of the new brand A+ |
| | razors. | upgraded razor for women. |
| 5 | Female users of brand X or Y | Advantages of brand A/A+ over |
| | razors. | brands X and Y for women. |
| 6 | Female users without an | Generic introduction/description |
| | expressed preference. | of brand A/A+ razors for |
| | | women. |

Additional variants of the advertisement may be created for users in particular age groups, geographic areas, and income levels, to name a few factors. As a further example, users with income levels at a certain point may see an advertisement for an electric shaver, instead of a razor. Another example will be given below.

Table 1 presents a relatively simple example, in that for any one user, there is most likely only one applicable advertisement variant. However, with more advertisement variants, situations may often arise in which more than one advertisement variant might be shown to a user. For example, if there were advertisement variants for different age groups, different geographic locations, and different income levels, as well as different brand buying behaviors, the user might be shown any one of four advertisement variants: one variant for his or her age group, one for his or her geographic location, one for his or her income level, and one for his or her buying behaviors.

Situations in which a user might be shown any one of a number of advertisement variants can be resolved in a number of ways. First, an advertiser or the operator of method 10 may designate an order of precedence. In that case, using the example from above and assuming that a user might be shown any one of the four advertisement variants described above, the advertiser or the operator of method 10 might dictate that he or she shown the advertisement variant for his or her age group. An advertiser or the operator of method 10 might further specify that if a user qualified to see a particular geographic variant, a buying behavior variant, and a variant for his or her income level, he or she should be shown the advertisement variant related to his or her buying behavior. In that manner, rules could be devised to define which advertisement the user would be given to view if there are multiple possible advertisement variants for that user.

While rules and decision trees are one way in which a particular advertisement variant may be selected for a particular user from among multiple possibilities, the nature of method 10 also allows advertisements to be selected based on feedback from other users. As will be described in greater detail below, after viewing an advertisement, users may be asked either immediately or some period of time later how they liked the advertisement, how likely they are to buy the advertised product after seeing the advertisement, and other types of feedback questions. That feedback could be used to determine which advertisement variant a user is given to view in some embodiments.

For example, assume that males 25-30 years old with a certain income level and certain brand buying or usage behavior seem to prefer the advertisement variant that targets the brand behavior over the variant that targets the age group. In some embodiments, the system could then be configured to show the brand behavior variant to that group, regardless of what other advertisement variants might be available.

In some embodiments, a particular advertising campaign might begin with basic rules set by the advertiser or by the operator of method 10 that describe which advertisements to show to which users, and then as the campaign progressed, the rules might be redefined based on user response to particular advertisement variants or level of user recall of the advertising messages in those variants. Methods for selecting advertisement variants will be described in more detail below.

Once the particular advertisement version or variant is selected for the user, method 10 continues with task 26, in which the user is provided the advertisement for viewing.

Advertisements may be provided and presented to the user in any appropriate format, depending on the manner in which method 10 is executed. If, for example, method 10 is carried out over the Internet with users connected to a central automated system by personal computing devices, then the advertisements may be delivered in any format and in any size or resolution compatible with the personal computing devices. For example, video advertisements may be stored and presented to the user using MPEG format, Windows Media Player format, or Quicktime format, to name a few. Audio advertisements may be presented in, for example, MP3, AAC, Windows Media Player or RealAudio formats. Video advertisements may also be transmitted using Adobe Flash technology. Static display advertisements may use any image format compatible with the user's personal computing device, including GIF format, JPEG format, PNG format, or TIFF format. Interactive games may be programmed in any appropriate language and presented in any compatible format including Java, Javascript/HTML, and Flash. Advertisements may also be tailored for special or adaptive delivery methods. For example, an advertisement could be tailored for delivery in large type, in audio format, or in Braille, if required. Additionally, if a user is an interactive television or digital cable subscriber and is participating in method 10 using those devices, advertisements may be tailored and presented as part of the user's “on demand” content.

One decision in implementing method 10 is whether to provide the advertisements to the user in a permanently downloadable form, or whether to provide only temporary or partial access to the advertisements. In some embodiments, it may be preferable to provide only limited or one-time access to the advertisement or advertisement, for example, by allowing the user to access it by a streaming file transfer protocol, rather than by providing it outright as a single file download. Streaming an advertisement, for example, minimizes space demands on the user's personal computing device and may allow an operator of method 10 better control over how many users are viewing a particular advertisement. If desired, rights management or other similar technologies may be applied to the advertisement or advertisements to control their distribution.

After the user has been presented with the advertisements, method 10 continues with task 28, an optional but advantageous task, in which the operator of method 10 confirms that the user has paid attention to the advertisement or advertisements and, also optionally, asks any questions about the user's response to the advertisement and views on the advertised product after seeing the advertisement. Confirming that the user has paid attention to the advertisements may involve slightly different actions, depending on the embodiment. In the simplest embodiments, confirming that the user has paid attention to the advertisement may comprise simply checking that the advertisement reached the user's personal computing device.

However, more advantageously, confirming that the user has paid attention to the advertisements comprises eliciting some response from the user to confirm that the user has paid attention to the advertisement. One way in which this may be done is by asking the user a question or a series of questions that are focused on the content of the advertisement and can only be answered correctly if the user has actually paid attention to the advertisement or advertisements. For example, if an advertisement indicates that its product is “four times better than the competitor,” the user may be asked how many times better the product is than the competitor. If the advertisement had a particular tagline, the user might be asked what the tagline was. Generally, questions will reinforce the key message or messages of the advertisement. Questions could be written by the advertiser, by the operator of method 10, by the creator of the advertisement, or by some other party. Questions may be humorous, constructed as a game, or paired with an audiovisual display to engage the user.

In some embodiments, confirming that the user has paid attention to the advertisement or advertisements in task 28 may comprise forcing the user to perform some task that requires the user to be paying attention to the personal computing device where the advertisement is playing—like clicking on a particular area of the screen or answering a question—while the advertisement is playing. However, in most embodiments, it may be more advantageous to use questions that focus on the content of the advertisement because those types of questions act to reinforce the message conveyed by the advertisement.

Questions need not be asked only after an advertisement has been presented. Depending on the desires of the marketer or the operator of method 10, it may be advantageous to ask questions about a particular advertisement some time after the advertisement has been viewed, in order to gauge whether or not the user has actually retained the message conveyed by the advertisement. For example, questions about a particular advertisement or group of advertisements could be presented a few days or a week later, along with the kind of profile and behavior questions typically asked in task 22 prior to viewing another advertisement. Alternatively, additional, time-delayed questions about a particular advertisement could be presented when a user first logs in or identifies him or herself, prior to task 18. Additionally, in some embodiments, a series of questions may be asked as a survey, and the user may be offered the opportunity to take the survey and earn compensation when the list of available advertisements is presented in task 18. Answers to the questions may be recorded so that the operator of method 10 can provide the marketer with information on how well particular messages have been retained.

After an advertisement has been presented, a user may also be asked about his or her view of the product after the advertisement, and whether he or she intends to buy or use the product after viewing the advertisement.

Task 30 of method 10 is a decision task in which the operator of method 10 or the automated system determines whether the user has paid attention and/or whether the user merits compensation. If questions are asked in task 28, then, to the extent that the questions were recall questions with correct answers, task 30 may comprise a process of checking the user's answers against the correct answers to the questions. Typically, a user would need to answer a certain predetermined number or percentage of questions correctly (e.g., 80%) in order to confirm that he or she has paid attention to the advertisement and deserves compensation. If the user has paid attention and/or merits compensation (task 30:YES), method 10 continues with task 32; if the user has not paid attention or does not merit compensation, as indicated by not answering one or more of the questions correctly (task 30:NO), method 10 may return to task 26 and present the user with the advertisement again. A user may be given a set number of chances (e.g., two or three) to view the advertisement and answer the questions correctly before he or she is denied compensation for that advertisement and either blocked or returned to some other point in method 10, such as task 18. If the user repeatedly fails to pay attention to advertisements, the compensation levels for the user could be decreased or, in extreme cases, his or her account may be blocked or cancelled.

In task 32, the user is given some form of compensation in exchange for viewing the advertisement. Generally speaking, two types of compensation may be used in any combination in method 10 and in other methods according to embodiments of the invention: monetary compensation and promotional compensation.

The term monetary compensation generally refers to negotiable currency or its equivalent in electronic form, denominated in U.S. dollars or in the currency of another country or currency-issuing authority (other examples of currency include Canadian and Australian dollars, Euros, and Japanese Yen, to name a few). The term promotional compensation refers to other forms of compensation, which are usually tied to a particular product or service. Forms of promotional compensation may include product discounts, coupons, incentives, sweepstakes entries, free products, free content (television shows, music, video clips, articles, etc.), charitable donations made on behalf of the user, and “bonus points” or other credits, like frequent flier miles, that are redeemable through a particular vendor or vendors.

In many embodiments, the compensation given in task 32 will be monetary compensation or a form of promotional consideration—like generic “credits” or “points”—that the user can redeem or use relatively freely. The amount of compensation given may vary from advertisement to advertisement, depending on the budget provided by the advertiser, the desires of the operator of method 10, the length of the advertisement, the total number of questions that the user was asked to answer, the number of questions that the user answered correctly (for questions that had designated correct answers), and any other factors that the advertiser or the operator of method 10 choose to take into account.

Although each advertiser will generally provide a budget to the operator of method 10 for providing compensation to users for viewing its advertisements, the type and amount of compensation will generally be left to the discretion of the operator of method 10. In some embodiments, the operator of method 10 may pool budgets and resources from multiple advertisers to compensate users, or may cross-promote products featured in advertisements. Additionally, as was noted above, the operator of method 10 may implement a system in which an “attention price” or amount of compensation for viewing an advertisement is determined for each user or selected by the user, as described in U.S. patent application Ser. No. 11/382,616.

Typically, the operator of method 10 would maintain an account balance for each user along with his or her other profile information. Compensation may be transferred to the user only at intervals, or only under certain conditions. For example, compensation might be transferred to the user only once a month, or only if the user's account balance reaches a threshold balance, e.g., $5.

Financial transactions may occur using any means deemed desirable by the operator of method 10. Appropriate means for conducting financial transactions include automated clearing house (ACH) deposits to a user's personal accounts, credits to a user's credit card, and third party payment services, such as PAYPAL. Payment may also be made in the form of credits for mobile phone minutes, discounts off the monthly cable bill, free gasoline, or media content. Non-monetary or promotional compensation may be distributed by direct arrangement with the provider of the product or service (e.g., free cell phone minutes are credited directly to the user's cell phone account), or by means of discount codes or coupons recognizable by the provider of the product or service. For example, if the promotional compensation is a store gift certificate, it may be distributed in the form of a code recognizable by the store, or offered as a paper coupon with a bar code readable by the store, or offered as a credit to be paid at the store using a mobile device. Any conventional anti-tampering methods may be used to secure promotional compensation codes or certificates from duplication or fraud.

Method 10 may continue with task 34, an optional task. In methods according to embodiments of the invention, compensation provides an incentive for the user to view an advertisement. However, it is advantageous if the user is also provided with an incentive to buy and actually use the products that are advertised. Therefore, in task 34, the user may be given a coupon, offer, or other incentive that encourages him or her to buy and use the advertised product. That coupon, offer, or incentive may pertain to the advertised product or, in some embodiments, it may pertain to a complementary product or be conditioned on the purchase of the advertised product. For example, if the advertised product is the Brand A Razor, the coupon could be for a free package of razor blades with the purchase of the razor handle.

As with other tasks, the operator of method 10 generally has control over which advertisements and coupons, offers, or incentives are presented to which users. Therefore, in some embodiments, it is possible that the product for which the user is given the coupon, offer, or incentive will not be directly related to the product for which the user has viewed the advertisement. For example, if the advertised product was a Brand A razor, the user might be offered a coupon for 50 cents off another company's shaving cream, or 50 cents off another company's shaving cream if the user purchases the advertised Brand A razor.

Furthermore, that coupon or offer may be tailored to the traits established in task 20 and the particular variant of the advertisement with which the user was provided in task 24. To continue the razor example from above, users of the advertised brand A razor might receive a coupon for additional razor blades, while users of other brands, and users who have not expressed a brand preference, might receive a coupon for the razor handle. The methods of selecting an advertisement variant described above with respect to task 24 may also be applied to the selection of a coupon, offer, link, or other incentive for the user, and particular advertisement variants may be associated with particular coupons, offers, links, or other incentives.

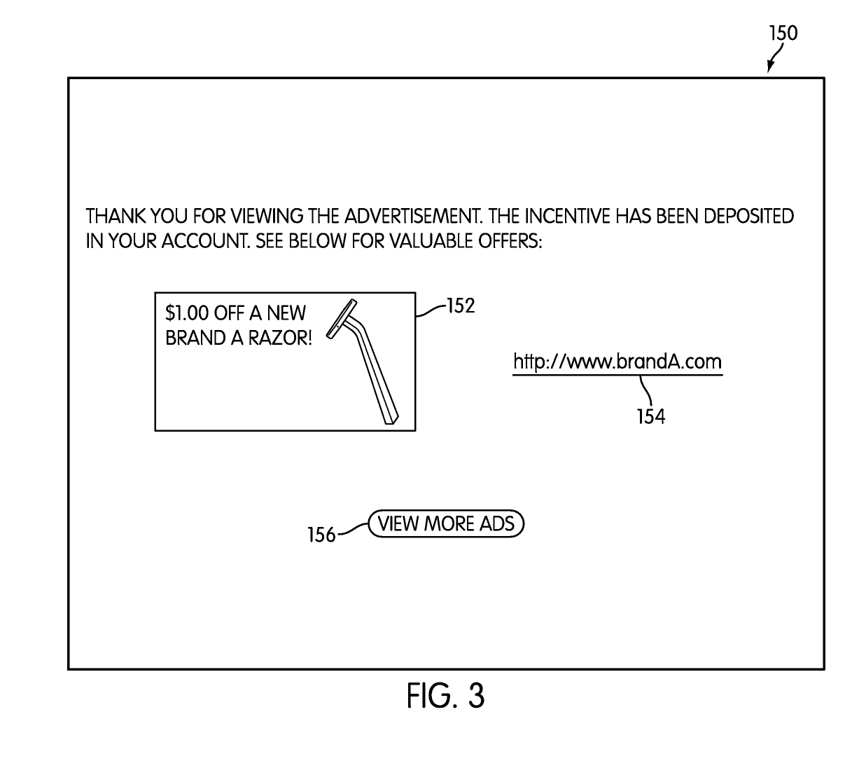

FIG. 3 illustrates an exemplary direct response screen 150. The direct response screen 150 includes a coupon 152, which may differ depending on user traits, and a link 154 to the brand A company website for further information. The direct response screen 150 also includes a control 156 that allows the user to return to the advertisement selection screen 100 to view more advertisements. If the user was drawn into method 10 from an external page or place (e.g., by clicking on an advertisement), he or she may be given an option or control allowing a return to that page or place. If the user decides to click on the link 154 to go to the brand or company website, that information may be tracked and recorded by the operator of method 10.

In some embodiments, the compensation scheme may differ somewhat from that described above. For example, a user could be given a sweepstakes entry for every advertisement that he or she views, optionally up to a certain maximum number of advertisements in a particular time period. At the end of a designated time period, for example, at the end of the week or month, larger prizes could be awarded to selected recipients.

Once the direct response screen 150 is shown, the user's involvement in method 10 is essentially complete: he or she has answered questions to establish his or her traits, has been presented with an advertisement, has been compensated for his or her attention to the advertisement and, optionally, has been presented with coupons or other direct response items. Of course, a user may repeat method 10 any number of times, subject only to any frequency rules put in place by the operator of method 10.

In most, if not all, embodiments, the operator of method 10 will wish to monitor the effectiveness of the various advertising campaigns. Additionally, as was noted briefly above, the operator of method 10 may wish to update the rules governing which users are shown which advertisement variants.

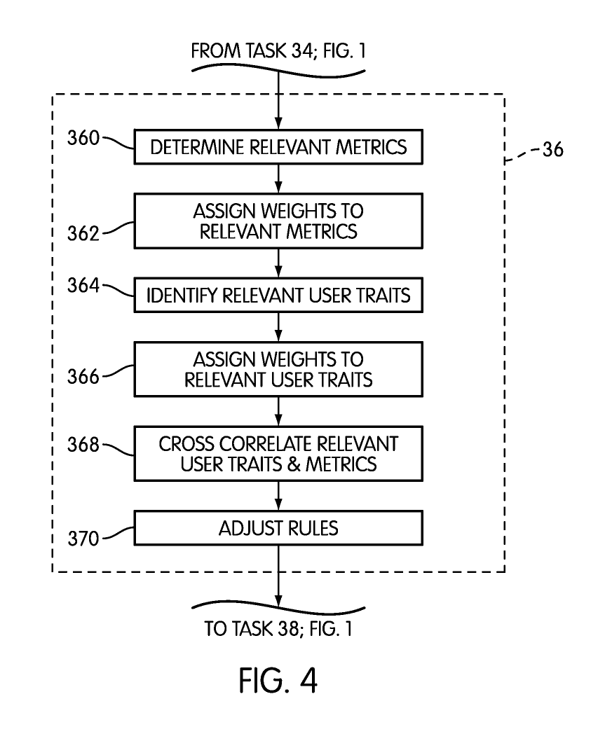

One method of performing task 36—monitoring and optimizing the effectiveness of a particular advertising campaign—is shown in the flow diagram of FIG. 4. As shown, task 36 begins with task 360, in which the relevant metrics are determined.

For any one advertising campaign, a number of metrics may be deemed relevant. Several examples of potentially relevant metrics include the rate at which users clicked through to the advertiser's web site on the direct response screen 150 for additional information (also called the click through rate or CTR), the number or percentage of users who indicated after viewing an advertisement that they were more likely to buy or use the advertised product (purchase intent), the number or percentage of users who indicated that they found the advertisement itself to be likeable (advertisement likeability), and the number of users who chose to view an advertisement from a particular advertiser or an advertisement of a particular type from among all of those deemed appropriate and presented in task 18.

As an example, assume that for a particular advertising campaign, CTR and likeability are determined to be the most important metric. Task 36 then continues with task 362, in which relative weights, indicating degree of importance, are assigned to the relevant metrics. Thus, if CTR and likeability are determined in task 360 to be the most relevant metrics for a particular campaign, CTR might be assigned a relative weight of 50, likeability a relative weight of 30, purchase intent might be assigned a relative weight of 10, and advertisement likeability might also be assigned a relative weight of 10.

Task 36 continues with task 364, in which relevant user traits are identified. The relevant user traits may be any demographic, psychographic, or behavioral traits. Some examples of traits that may be considered include age, gender, location (by postal code, for example), income level, and brand usage. As shown in task 366, relative weights, indicating degree of importance, may also be assigned to user traits.

Once relevant metrics and user traits are identified and weighted, task 36 continues with task 368, in which the relevant metrics and the relevant user traits are cross-correlated. The results of that analysis may be reported to advertisers as evidence of the effectiveness of a particular advertisement or family of advertisements in a particular sector of the market, and they may be used by the operator of method 10 to change the rules governing which advertisement variants are shown to which users.

For example, assume that it was discovered as a result of task 368 that men aged 18-24 clicked-through in response to a particular advertisement variant at a rate of 15%, while that same group clicked through in response to another advertisement variant in the same family of advertisements at a rate of only 5%. In that case, the operator of method 10 may choose to show all men aged 18-24 the advertisement variant that generated the higher click through rate. Any statistically significant difference in the responses to different advertisement variants in the same family may motivate a change in the rules governing which advertisements are shown to which users. As those of skill in the art will appreciate, these sorts of changes may be made as soon as statistically significant differences in user response appear, most likely after less than several thousand viewings of an advertisement family, as a large sample size is not necessarily required to yield actionable results. In some embodiments, optimizations and rule changes may be governed by an automated system; in other embodiments, the optimizations and rule changes may be individual personal judgments made by a human manager. However the changes are made, an advantage of method 10 is that the changes can be made while the advertising campaign is still underway.

As a more expansive example of how tasks 360-370 may be performed, Table 2 contains basic traits and information on four users who have participated in an advertising campaign for the fictional Brand X Peanut Butter. Table 3 contains information on the brand behavior of those users and on their responses to the advertising campaign.

TABLE 2
Example Basic Data on Users from Brand X campaign.

| Adver- | | | | | | | |
|---|---|---|---|---|---|---|---|
| tisement | | | | | Postal | | Household |
| Version | Offer | User ID | Gender | Age | Code | Income | Size |
| 1 | A | 1001 | F | 25 | 10003 | 100 | 3 |
| 2 | A | 1002 | M | 25 | 20008 | 125 | 5 |
| 3 | B | 1003 | F | 25 | 10001 | 230 | 2 |
| 1 | B | 1004 | F | 24 | 94608 | 100 | 1 |

TABLE 3
Example Data on User Behavior from Brand X campaign.

| | | | | Purchase | |
|---|---|---|---|---|---|
| | | Clicked | Positive | Frequency | |
| User ID | Brand Used | Through | Intent | (year) | Rating |
| 1001 | X | Y | 55% | 3 | 50 |
| 1002 | Y | N | 40% | 2 | 20 |
| 1003 | Y | Y | 30% | 3 | 80 |
| 1004 | Z | N | 35% | 4 | 30 |

More specifically, Table 2 records which version of the advertisement and which incentive or direct response offer the user was shown, along with the user's gender, age, postal code, income level (in thousands of dollars per year) and household size. Table 3 includes information on their response to the advertisement, direct response offer, and questions. In particular, Table 3 details the brand of peanut butter that the user uses, whether or not they clicked through to obtain further information about the product from the manufacturer or retailer after the advertisement was shown, the degree to which the user expressed a positive intent to purchase the product, how often the user purchases the product or type or product, and a rating, which is a computed metric based on an amalgam of user traits and responses to the advertisements and offers. In this case, the rating is constructed such that a lower rating implies that the user has desirable traits and is more likely to be affected by the advertisement and to buy the product.

Generally, if computed metrics like ratings are used in method 10 and other methods according to the invention, the ratings, and the weights assigned to the various traits and metrics in order to compute the ratings, may be determined based on users who have actually viewed a particular advertisement and then applied to other users with similar traits who have not viewed a particular advertisement, as was described above. Statistical analyses may be performed on any of the recorded data to determine whether a particular user trait is strongly correlated with positive purchase intent or actual product purchase. The degree of correlation may determine how strongly a particular trait is weighted.

As an example of the way in which a rating, or another such computed metric, can be calculated and used, take the case of user no. 1003 from Tables 2 and 3. User 1003 is 25 years old, and is a relatively affluent consumer with an income of $230,000 per year living in New York City (postal code 10001). Those traits would be desirable for most marketers and most brands. However, despite those positive traits, this particular user expressed a very low (30%) intent to purchase the advertised product after viewing the advertisement and clicking through to see additional information from the manufacturer. Therefore, the experience with user 1003 may indicate that users with traits like those of user 1003 are unlikely to be affected by the advertising. Assuming that is the case, the user might receive 10 rating points for being a user of competing brand Y, 10 rating points for being in that particular geographic area, 10 points for having a high income, 10 points for clicking through to see additional information, and 40 points for having a low positive purchase intent, for a final rating of 80 points. In this case, the purchase intent of the user after viewing the advertisement and any additional offers or information is weighted much more heavily than any other trait.

Given the above, Table 4 below illustrates how rules might be defined or redefined for the campaign:

TABLE 4
Rules for Brand X Peanut Butter Campaign.

| Advertisement | |
|---|---|
| Version/Offer Version | Show To |
| 1/B | Men and Women, 18–34, income level at |
| | least $100K, rating >30 |
| 2/A | Women 25–35, income level at least $150K |
| | who use Brand Y Peanut Butter |
| 3/B | All Men and Women ages 45 and greater |
| | with income level at least $90K |
| 2/A | All remaining users with rating <40 |
| 2/(No offer) | All remaining users with rating >40 |

Thus, as shown in Table 4, for the Brand X Peanut Butter campaign, particular advertisement variants with additional incentives or offers will continue to be shown to users with particular traits; however, users who do not fall into one of the defined categories and have a rating greater than 40 will be shown an advertisement variant with no accompanying incentive or offer beyond any basic amount of compensation they receive in exchange for viewing the advertisement.

The sub-tasks of task 36 conclude after task 370, in which any adjustments or rule optimizations are made. Following that, as shown in FIG. 1, method 10 completes at returns at task 38. It should be understood, however, that method 10 may be executed a multitude of times in parallel, each time with a different user and/or different advertisements. Therefore, certain administrative tasks, such as task 36, may be performed at any point.

As was described above, questioning a user is not the only method for ascertaining a user's traits. One particularly advantageous method for ascertaining a user's brand buying and usage habits is to obtain actual product purchase information. Such information is useful in the conduct of a method such as method 10, but it is also useful information in its own right.

Product purchase information may be obtained from merchants, but information provided by a single merchant may cover only the user's behavior with respect to that merchant. Therefore, a more advantageous method may be to ask the user to provide purchase information from a variety of merchants, either by scanning the UPC codes for items in his or her home, providing receipts from purchases, or by supplying some other documentation of purchases. Using this information, an interested party can establish not only what the user has bought, but in what quantity, with what frequency, and with which other products, to name a few useful categories of information. It can also be determined how a user's buying behavior has changed over time. Of course, a user may be questioned to establish that sort of information, but it may be faster and easier for a user to scan products, or supply receipts, than for the user to answer a lengthy questionnaire with answers that may or may not be completely accurate.

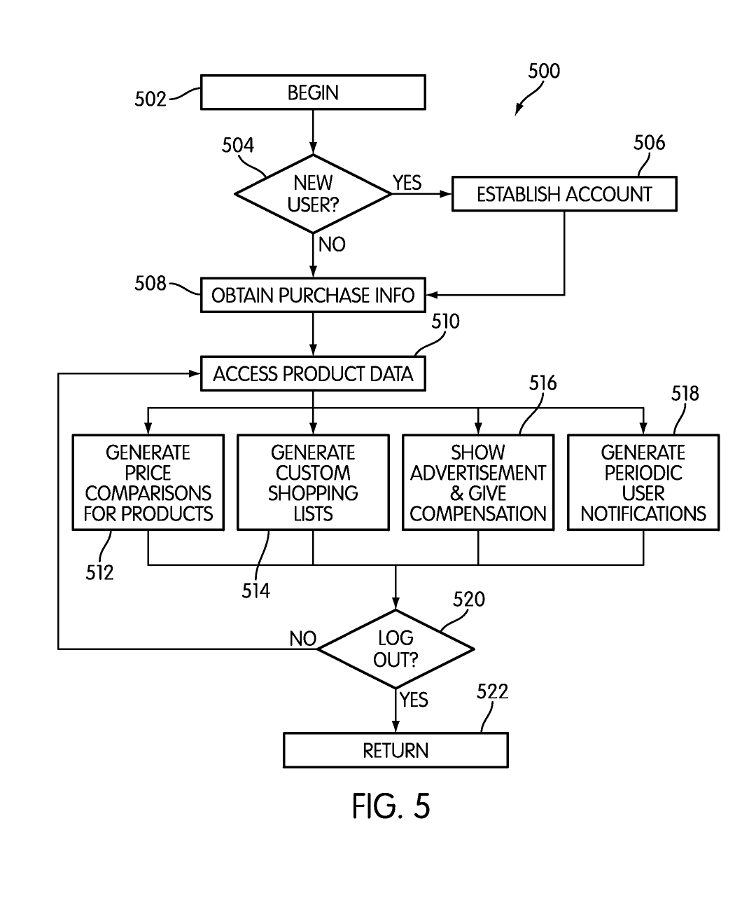

FIG. 5 is a flow diagram of a method, generally indicated at 500, for obtaining and using purchase information from the user. Method 500 begins with task 502 and continues with task 504. Method 500 may be offered in combination with or separately from a method such as method 10. If method 500 is offered in combination with method 10, the same user information may be used for both methods. As with method 10, the user generally enters into and participates in method 500 using a personal computing device in communication with an automated system under the aegis of the operator of the method through a communication network.

Tasks 504 and 506 of method 500 generally correspond to tasks 14 and 16 of method 10, in that it is determined whether the user seeking to participate in method 500 is a new user and, if so, he or she is asked to establish an account. If the user in question is also a user of method 10 and the two methods are being offered in combination, the user information from method 10 may be used for method 500 and the user may not be required to sign up for a new account. Otherwise, the flow of tasks would proceed much as described above and the user would provide basic profile information for method 500.

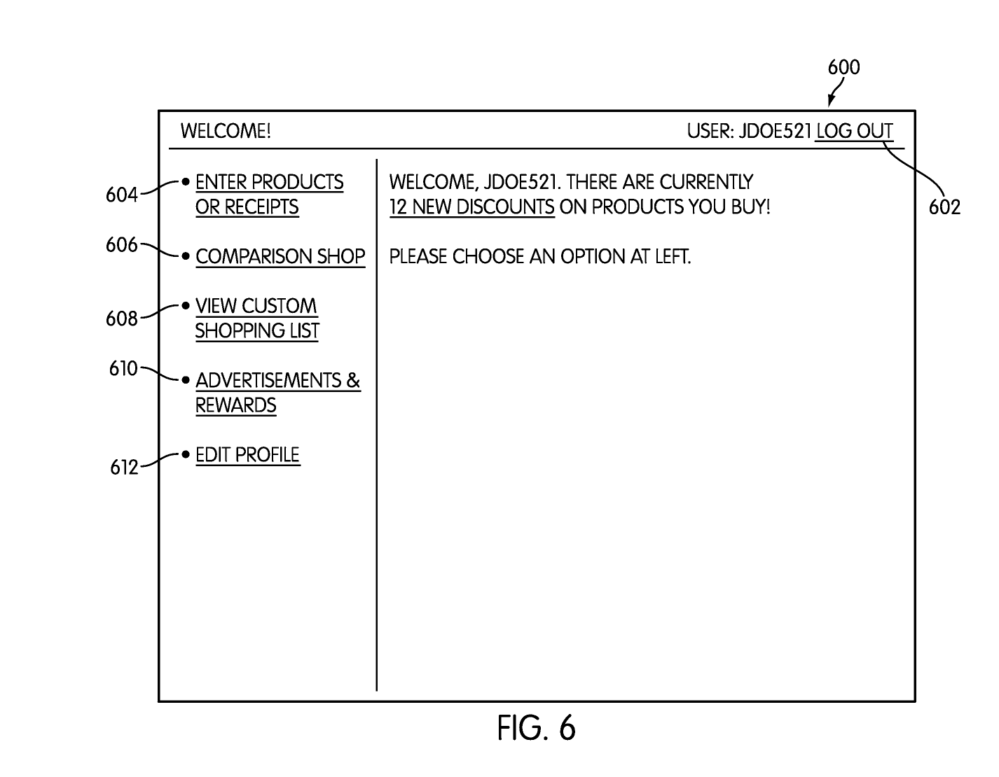

FIG. 6 is an illustration of an exemplary basic screen or home page 600 that a user would see on his or her personal computing device. The home page 600 acknowledges that the user has logged in and provides a log out link 602. The home page 600 also provides links for the basic tasks of method 500, including a product entry link 604, a comparison shopping link 606, a customized shopping list link 608, an advertisement link 610, and a profile link 612, which provides the user the ability to edit basic contact and profile information.

With respect to method 500, once a user has logged in, the next task in the method, task 508, is to obtain purchase information from the user. Therefore, in some embodiments, if the user has not provided any purchase information, he or she may be directed automatically into a screen that enables him or her to do so, and other method options may not be allowed until a sufficient amount of purchase information is entered. However, in other embodiments, even if the user has not entered purchase information, the user may be permitted to participate in some aspects of method 500. This will be described below in more detail.

There are several ways in which purchase information could be obtained from the user. First, a user might be provided with a Universal Product Code (UPC) scanner and asked to scan the UPC codes of grocery and other items already in his or her home. Second, a user might be asked to scan purchase receipts from grocery and other stores into image form and transmit the images to the operator of method 500. Those images would then be entered either by optical character recognition of the text or by manual entry. Third, a user might be asked to key in or otherwise enter the information from one or more receipts. Finally, a user might be asked to mail receipts, copies of receipts, clipped UPC codes, or other forms of proof of purchase to a specific address, where they could be either scanned and recognized via OCR or entered in some other fashion by the operator of method 500 or the operator's subcontractor or designee. Additionally, in some embodiments, purchase data might be sent directly from a store or merchant to the operator of method 500.

Typically, the operator of method 500 will be in communication with a data source that correlates UPC codes with product names and descriptions. If the user enters an ambiguous UPC code or one that is unknown to the operator of method 500, the user may be asked to clarify the nature of the product purchased by selecting from among several options or by entering the name and identifying information for the product.

As was noted above, the user may begin full participation in method 500 at any point after the operator of method 500 has sufficient purchasing information from the user. What constitutes sufficient purchasing information may vary by the embodiment, the traits of the user, the desires of the operator of method 500, and other circumstances. However, in general, the operator of method 500 may have sufficient purchasing information if the operator of method 500 has information indicating that the user purchases at least one product known to the operator of method 500. In some embodiments, a user may be asked to enter a grocery receipt for a full week's worth of food. Users may also be asked or required to enter additional receipts regularly in order to continue participation in method 500.

Once purchase information has been obtained in task 508 of method 500, method 500 continues with task 510. In task 510, the UPC codes or product lists that the user has entered or provided are stored, correlated with product names and information, and compared with lists of products that the operator of method 500 is currently marketing.

After task 508, method 510 may branch into any one of a number of different tasks, depending on the preferences of the user and the operator of method 500. As was described above, on the home screen 600, the user can select a number of links 604, 606, 608, 610, 612 that determine the course of method 500.

If the user selects product entry link 604, he or she is returned to task 508 of method 500 and allowed to enter additional products by any of the methods described above.

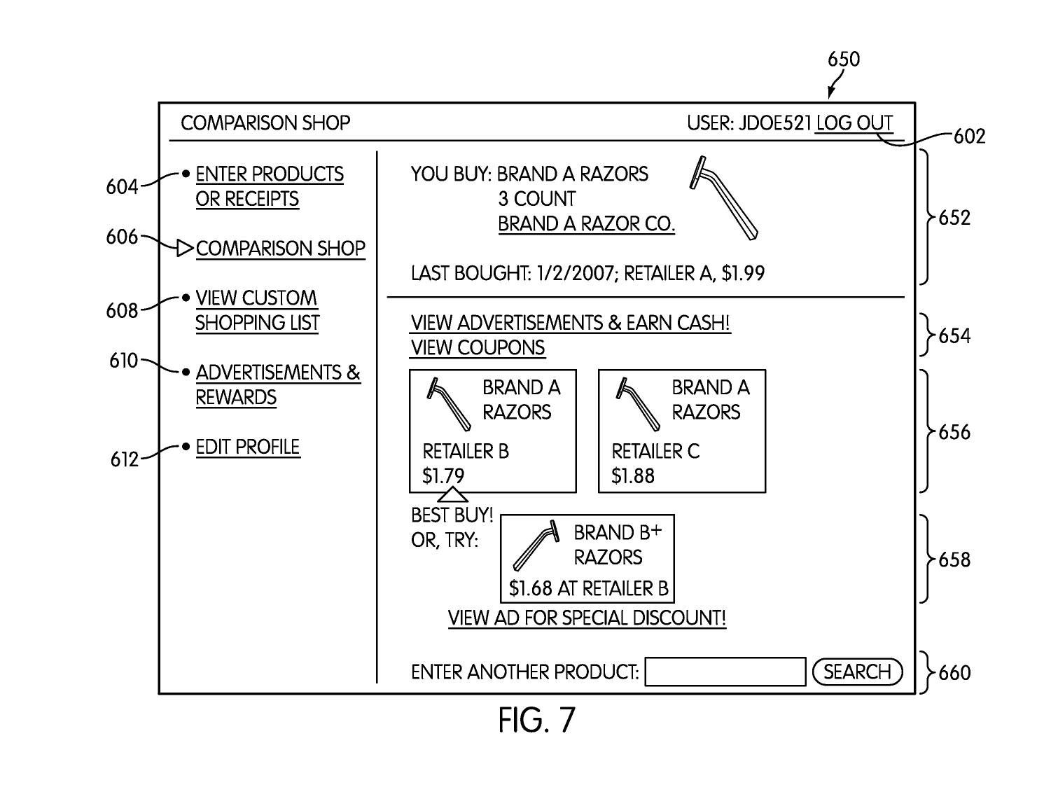

Comparison shop link 606 and corresponding task 512 of method 500 allow the user to compare prices and product information for a single product or multiple products among multiple retailers. Thus, method 500 allows trade marketing, as well as product marketing. For the user, price comparison task 512 aims to find a product for the user at the cheapest price. FIG. 7 is an illustration of an exemplary comparison shopping screen 650 with which a user would be presented. On the left side of the comparison shopping screen 650 are the same links 604, 606, 608, 610, 612 as on the home screen 600.

On the right side of the screen is a product display area 652 that provides information on a single product under consideration. In FIG. 7, the product under consideration is the Brand A razor, and comparison shopping screen 650 displays in the product display area 652 the name of the product, the details of the product, the date that the product was last purchased, the retailer from whom the product was last purchased, and the price that was last paid. In the illustrated example, the user last purchased a three-count package of brand A razors from retailer A on Jan. 2, 2007 for $1.99.

Beneath the product display area 652 is a related links area 654. The related links area 654 may offer links to a number of cross-marketing and/or synergistic offers and opportunities. In the illustrated example, the related links area 654 offers links that allow the user to view advertisements and earn compensation for viewing the advertisements, and for viewing coupons. If the user selects these links, he or she may be taken into a method like method 10 or the methods disclosed in U.S. patent application Ser. No. 10/474,242, in which he or she is compensated for viewing advertisements for the product.

The price comparison area 656 of the comparison shopping screen 650 shows the prices of the product under consideration at other retailers, in the illustrated embodiment, the prices of brand A razors at retailers B and C. The best price may be identified graphically in a special way so as to stand out for the user's benefit.

Comparison shopping screen 650 also includes a comparable product area 658. The comparable product area 658 displays products that are comparable to the product that the user is currently purchasing, and may or may not provide the user with an incentive to purchase those alternative products. As shown, links accompanying the product display in the comparable product area 658 may also include a link that allows the user to view an advertisement for the product in exchange for compensation. Additionally, if the user clicks on one of the products depicted in the comparable product area 658, that product may be added to a customized shopping list for the user, which will be described below in more detail.

Finally, comparison shopping screen 650 includes a search area 660, in which a user can enter another product name to bring up information on that product.

As shown in FIG. 7, comparison shopping screen 650 provides a variety of useful information for the user, including information on where the user can find the product least expensively, and information on competing products. The manner of finding information on products may differ from embodiment to embodiment: in some embodiments, the system may automatically determine which products the user needs to re-purchase based on usage information and display those products, instead of requiring the user to enter a product name or manufacturer.

However the precise nature and type of information presented to the user on comparison shopping screen 650 in most embodiments will depend on the desires and interests of the operator of method 500. For example, in FIG. 7, an advertisement for Brand B+ razors appears in the comparable product area 658. The manufacturer of Brand B+ razors may pay the operator of method 500 for the opportunity to have its products displayed in the comparable product area 658. Similarly, the retailers shown on comparison shopping screen 650 may have paid the operator of method 500 a fee in order to appear there.

Generally, it is to the benefit of the operator of method 500 to present complete and accurate product information to the user 650, so that the user can rely on the information and will continue to use method 500. However, the information may be presented in any format and, in some embodiments, manufacturers or retailers who pay a fee to the operator of method 500 may have their products or stores featured more prominently or highlighted on comparison shopping page 650 than the stores and products of other manufacturers or retailers, without distorting the underlying information.

Other types of information that could be included on comparison shopping screen 650 include detailed product specifications, nutritional information (for food items), and links to manufacturer websites.

In task 514 of method 500, the user may be provided with customized shopping lists. These customized shopping lists may be based on the customer's product purchasing and usage history, with products added to the customized shopping list when the operator of method 500 projects or estimates that the user will need to re-purchase the product. Additionally, products may be added to the customized shopping list from the comparison shopping screen 650 or from other areas if an appropriate link is provided. Moreover, if the user is participating in method 10 as well, a product may be added to the customized shopping list from a screen such as direct response screen 150. Alternatively, with respect to method 10, if a user views an advertisement, that advertisement could be added automatically to the user's customized shopping list in some embodiments.

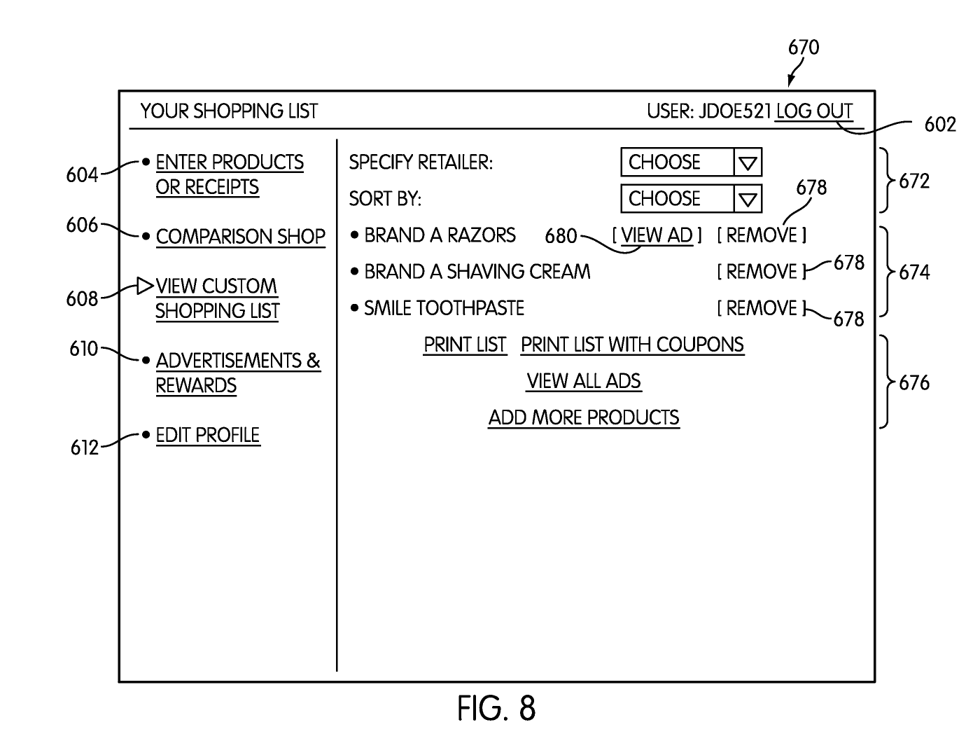

FIG. 8 is an illustration of an exemplary customized shopping list screen 670. The customized shopping list page 670 includes a sort selection area 672, a list display area 674, and an options area 676. The sort selection area 672 allows a user to specify a retailer and the manner in which the products on the list are sorted and displayed. In other embodiments, the sort selection area 672 may allow the user to specify other search or sort criteria, such as sorting by brand, manufacturer, or product type.

The list display area 674 displays the actual list of products. For each product, the user is given the option to remove the product from the list by clicking on a removal link 678. Additionally, if the user is participating in method 10 and an advertisement is available for a particular product, the user may be shown an ad view link 680 that will take the user into method 10 to view the appropriate advertisement.

Depending on the embodiment, the list display area 674 may include a great deal more information than that illustrated in FIG. 8. For example, if the user specifies a particular retailer using the sort selection area 672, the list display area 674 may include the prices for the products at that retailer, if the information is known. The list display area 674 may also include pictures of the items, additional description, and any other information deemed necessary or appropriate in helping the user to locate and purchase products.

In options area 676, the user is presented with links that allow the user to print the customized list, print the customized list with applicable coupons and discounts, view advertisements related to the products on the list, and add more products to the list. Additionally, if the retailer in question has a relationship with the operator of method 500 that allows the ordering of products online, either for delivery or for pickup at a local store, a link may be provided that allows the user to order the products from that retailer.

As was described briefly above, and as is indicated in task 516 of method 500, method 10 and method 500 may be used synergistically together. At any point, the user may click on advertisement link 610, or may be taken into method 10 in some other matter to be shown advertisements in exchange for compensation. Additionally, in some embodiments, users of method 10 may be drawn into method 500 in a similar manner and, as indicated above, controls allowing a user to add an advertised product to his or her custom shopping list may be included on a direct response screen 150 or at other points in method 10.

If method 10 and method 500 are used together, the compensation given in method 10 in exchange for viewing advertisements may be chosen to complement the objectives of method 500. For example, compensation given in method 10 may include coupons or additional discounts that are specific to the products for which the user has viewed advertisements. Additionally or alternatively, a user who is enrolled in method 10 and who has viewed advertisements may be given a general discount or preferred pricing on some or all products through method 500. Moreover, users may be given additional compensation for proving that they have purchased advertised products. Proof of purchase may be confirmed in task 508 of method 500 when purchase information is obtained from the user. However, proof of purchase of specific items may also be obtained by using individual receipt tickets, as disclosed in U.S. patent application Ser. No. 11/382,616, rather than relying on a single receipt for a plurality of items.

The description above generally assumes that the user seeks out the operator of methods 10 and 500 and actively requests to participate in those methods. However, as shown in task 518 of method 500, in some embodiments, the operator of methods 10 and 500 may seek out the user, either initially or on a continuing basis. The operator of methods 10 and 500 may do this by sending communications—in the form of mailings, e-mails, text messages, instant messages, multimedia and video advertisements, and telephone calls, to name a few—directly to the user. These communications may be targeted to the particular user with as much specificity as possible. The content of the communications is limited only by the technical limitations of the medium of communication.

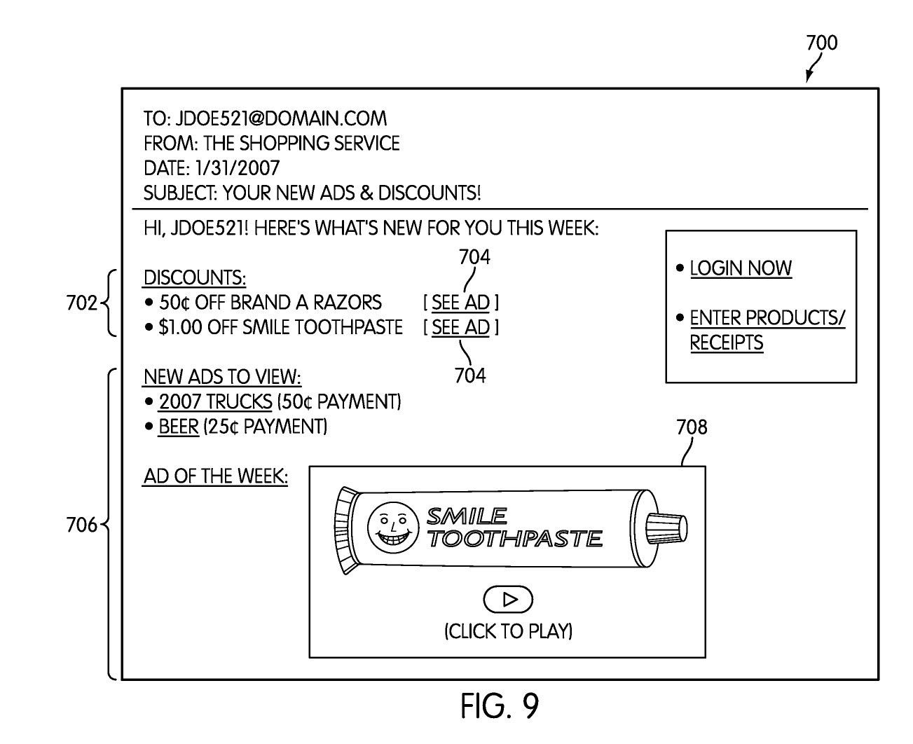

As one example, FIG. 9 illustrates an e-mail 700 that may be sent to a user. E-mail 700 includes a discount section 702 that lists discounts and promotions for products that the user is known to purchase (or products that the user is likely to purchase based on his or her products), complete with links 704 that allow the user to view advertisements related to those products for additional discounts or compensation. E-mail 700 also includes an advertisement section 706 that includes a listing of new advertisements that the user has yet to see, enabled as links so that the user can go immediately to those advertisements in method 10 by clicking on the respective links. Additionally, advertisement section 706 includes a selected advertisement that the user can play by clicking on the appropriate link. E-mail 700 also allows the user to log into his or her account and to go directly to task 508 of method 500 and provide purchase information. Thus, e-mail 700 entices the user to participate in both methods 10 and 500 by essentially bringing those methods to the user, instead of requiring the user to access a specific web site.

With respect to the flow diagram of FIG. 5, after one of the major tasks 512, 514, 516, 518 of method 500 is performed, the method continues with task 520, a decision task in which it is determined whether the user has chosen to log out and discontinue the method. If the user has chosen to log out (task 520:YES), method 500 returns at task 522; if the user has not chosen to log out (task 520:NO), method 500 may continue with task 510 or with any of the other major tasks 512, 514, 516, 518.

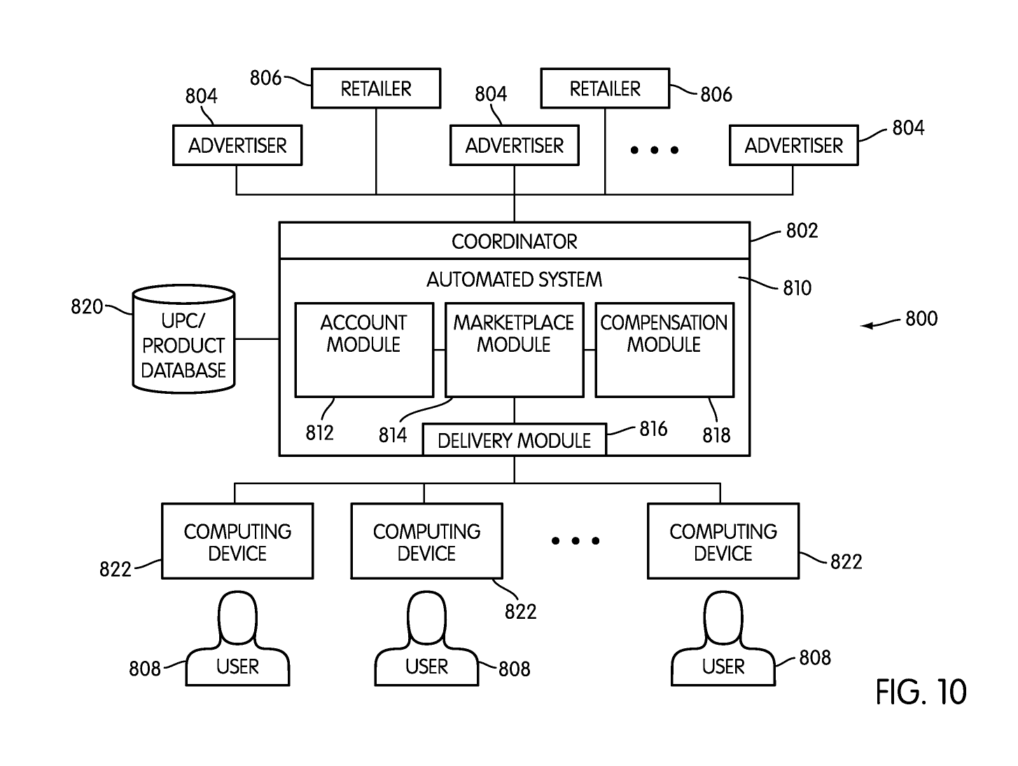

FIG. 10 is an illustration of an exemplary system, generally indicated at 800, that may be used in the execution of methods 10 and 500. At the center of system 800 is a coordinator 802. The coordinator 802 is generally responsible for the execution of methods 10 and 500, although it should be understood that in the description that follows, at least some of the functions ascribed to the coordinator 802 may be performed by third parties acting under the general direction or management of the coordinator 802. Moreover, in some embodiments, the coordinator 802 may provide a privately branded site or software package that appears to be sponsored or run by an organization other than the coordinator 802.

A number of advertisers 804 and retailers 806 interface with the coordinator 802, either in person or through automated systems. The advertisers 804 and retailers 806 are seeking to reach the users 808 through the coordinator 802 and to target their messages and products to the users 808 using methods such as methods 10 and 500, which are administered by the coordinator 802. For purposes of this description, an advertiser 804 is any entity that provides the coordinator 802 with an advertisement or message that is to be disseminated amongst the users 808, and a retailer 806 is an entity that sells advertised products. However, in some embodiments, there may be little practical distinction between an advertiser 804 and a retailer 806: an advertiser may be a retailer, and a retailer may be an advertiser.

The coordinator 802 typically has an automated system 810 that performs many of the functions described with respect to methods 10 and 500. Although shown and described here as one unitary automated system, the automated system 810 may include any number of intercommunicating, networked machines operating together to perform the necessary functions. Moreover, if a number of intercommunicating, networked machines are used, those machines may be co-located or geographically separated. The automated system 810 may be programmed in any programming language and in any manner. Functionally, the automated system 810 of the coordinator 802 has four general “modules” or functional units: an account module 812 that stores information about users enrolled in methods 10 and 500, their traits, and their buying habits; a marketplace module 814 that is responsible for storing and indexing the various advertisements and promotions that are offered, deciding which advertisements are appropriate for which users, storing statistics on the response to various advertising campaigns, and performing the administrative and supervisory tasks of methods 10 and 500; a delivery module 816 that is responsible for creating and delivering the various screens 100, 150, 600, 650, 670, advertisements, and communications to the user; and a compensation module that is responsible for delivering monetary and other compensation to the users 808. In some embodiments, the functions of these modules 812, 814, 816, 818 may be combined. Additionally, in order to correlate product information with UPC codes or other symbolic identifiers for purposes of method 500, the automated system 810 of the coordinator 802 may be in communication with an external UPC/product database 820.

The coordinator 802 may communicate with the users 808 in a variety of ways, as was described above. However, most contact with users 808 in system 800 is through personal computing devices 822, each of which may be any type of personal computing device described above or any personal computing device capable of carrying out the described functions. Although not shown in FIG. 10, the delivery module 816 may connect directly or indirectly with any form of wired or wireless communication network for the purpose of communicating with the personal computing devices 822.

Although not shown in FIG. 10, the account module 812 may be connected to and may receive user information from a variety of external sources, as was described above, instead of obtaining all information from the user.

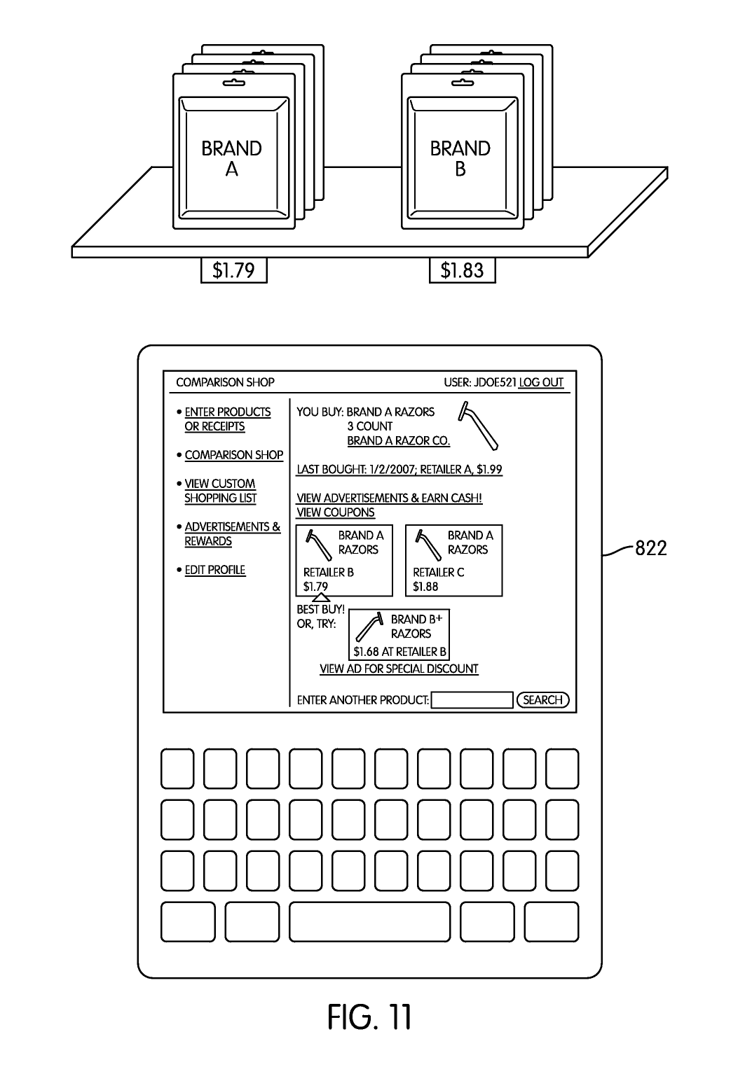

One benefit of using system 800 with method 500 and a portable, wireless personal computing device 822 is the ability to actively direct a user to a particular product while the user is in the store. FIG. 11 is an illustration of a wireless personal computing device 822 in a store. The user is considering two products, labeled brand A and brand B in the figure, and can access information on each of them using the personal computing device 822, which is participating in system 800 and method 500. As shown, the personal computing device 822 shows the comparison shopping screen 650 for the two products.

Depending on the embodiment and the capabilities of the user's personal computing device 822, some or all of the tasks of method 500 may take place while the user is actually in a store or at another point of purchase and is actively making a purchasing decision. For example, if the personal computing device 822 is portable and is equipped with a UPC scanner or a camera, the user can scan in UPC codes, photograph UPC symbols, or type in UPC codes while the user is in the store, and can use the comparison shopping screen 650 and custom shopping list screen 670 to compare prices and update his or her shopping list while in the store. Additionally, using either location-based services or general information on the user's location (e.g., using the user's postal code), coupons and incentives may be targeted to the user's location at that particular point in time.

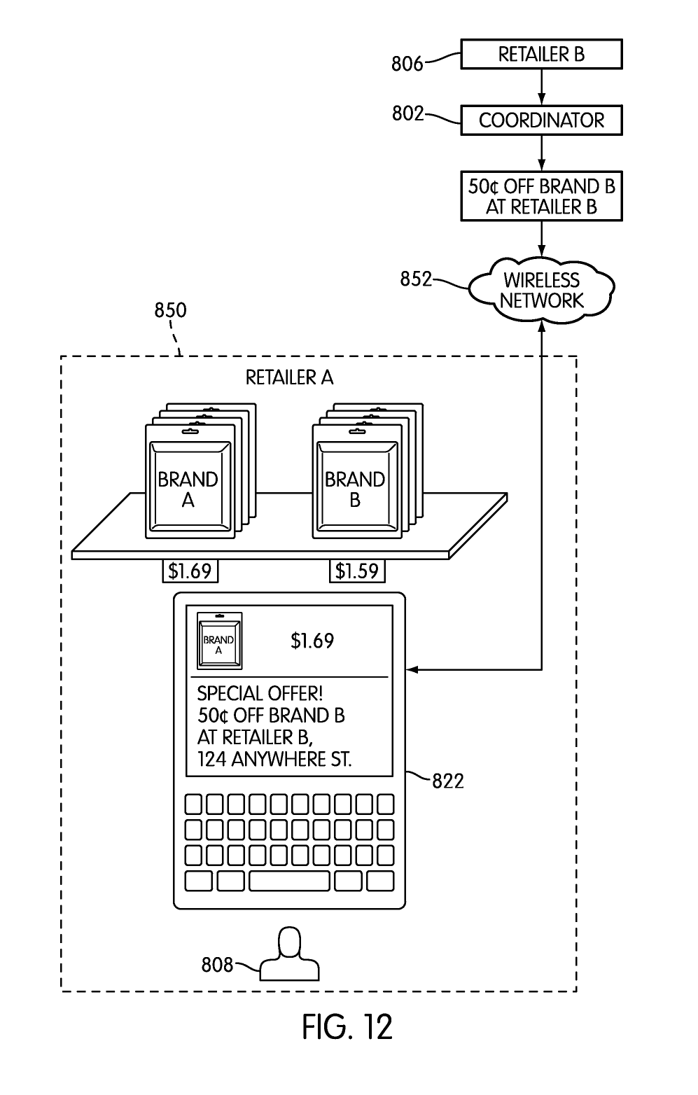

This concept is illustrated in FIG. 12, a simplified variant of system 800. In FIG. 12, a user 808 is within a Retailer A's store 850 with his or her personal computing device 822. The user is comparing two products on the shelf, shown in FIG. 12 as “Brand A” and “Brand B”, and has entered the UPC code of the Brand A product into his or her personal computing device 822. The personal computing device 822 is connected through a wireless network 852 to the coordinator 802.

In this example, the coordinator 802 notes that the user 808 has entered Brand A's information from Retailer A's store. However, in this scenario, it so happens that Retailer B, which competes with Retailer A, is a client of the coordinator 802 and subscribes to system 800. The coordinator 802 is thus aware that Retailer B is offering comparable product Brand B at a 50-cent discount, and so forwards that offer to the personal computing device 822 as part of the comparison shopping screen 650.

The coordinator 802 may keep a matrix of available incentive and coupon offers and situations in which those offers should be made in much the same way as advertisement variants are kept and tracked in method 10. A particular incentive offer may be made when particular pre-selected circumstances exist, as in the above scenario (a user scans or enters particular product information and the user has certain traits or is in a particular location), or a particular incentive offer may be made more broadly.

Thus, the methods and systems described here may increase the efficacy of advertisement targeting in a pay-for-attention model by targeting a particular variant of an advertisement to a user based on user traits. In addition, the methods and systems described may also increase the efficacy of the advertisements by collecting purchasing information from the user and offering product and brand information, advertisements, targeted incentives, and compensation to the user based on the purchasing information. Moreover, for retailers, method 500 in particular offers opportunities for trade marketing as well as product marketing. The methods and systems described here may be used together or separately.

Although the invention has been described with respect to certain embodiments, those embodiments are intended to be exemplary, rather than limiting. Modifications and changes may be made within the scope of the invention, which is determined by the claims.

What is claimed is:

1. A method of advertising, comprising:
establishing one or more of a user's demographic, psychographic, or behavioral traits;
allowing the user to indicate an interest in viewing an advertisement;
based on the established demographic, psychographic, or behavioral traits, selecting among several versions of the advertisement;
presenting the selected version of the advertisement to the user; and
compensating the user.

2. The method of claim 1, further comprising, after presenting the selected version of the advertisement to the user:
asking the user one or more questions relating to the selected version of the advertisement.

3. The method of claim 1, wherein establishing one or more of the user's demographic, psychographic, or behavioral traits comprises asking the user one or more questions.

4. The method of claim 1, wherein compensating the user comprises providing the user with monetary compensation.

5. The method of claim 1, wherein compensating the user comprises providing the user with promotional compensation.

6. The method of claim 5, wherein the type of promotional compensation is based on the established demographic, psychographic, or behavioral traits.

7. The method of claim 1, further comprising providing a purchase incentive to the user, the nature of the purchase incentive being based on the established demographic, psychographic, or behavioral traits.

8. The method of claim 1, wherein the several versions of the advertisement are different from one another.

9. The method of claim 8, wherein ones of the several versions of the advertisement are adapted for users of different traits.

10. The method of claim 1, further comprising gauging the user's response to the selected version of the advertisement.

11. A method of conducting an advertising campaign, comprising:
establishing one or more demographic, psychographic, or behavioral traits for each of a plurality of users;
associating particular demographic, psychographic, or behavioral traits with particular variants of an advertisement;
allowing each of the plurality of users to indicate an interest in viewing the advertisement;
for each of the plurality of users, presenting the advertisement variant that is associated with the particular demographic, psychographic, or behavioral traits of the user;
compensating at least some of the plurality of users;
gauging the response of the plurality of users to their respective advertisement variants; and
altering the association of particular advertisement variants with particular demographic, psychographic, or behavioral traits based on the response in order to increase the effectiveness of the advertising campaign.

12. The method of claim 11, wherein the altering is performed while the advertising campaign is underway.

13. The method of claim 11, further comprising:
associating particular purchase incentives with particular demographic, psychographic, or behavioral traits; and
providing at least some of the plurality of users with the purchase incentives based on the demographic, psychographic or behavioral traits of the respective users.

14. The method of claim 13, wherein particular purchase incentives are associated with particular advertisement variants.

15. The method of claim 11, wherein establishing one or more demographic, psychographic, or behavioral traits for each of a plurality of users comprises asking the each of the plurality of users one or more questions.

16. The method of claim 11, wherein compensating at least some of the plurality of users comprises providing at least some of the plurality of users with monetary compensation.

17. The method of claim 11, wherein compensating at least some of the plurality of users comprises providing at least some of the plurality of users with promotional compensation.

18. An advertising system, comprising:
a marketplace module adapted to:
accept data on one or more users,
associate user demographic, psychographic, or behavioral user traits with ones of a plurality of variants of an advertisement, and
select a particular advertisement variant for a particular user based on the user demographic, psychographic, or behavioral variants;
a delivery module adapted to transmit the particular advertisement variant to the particular user; and
a compensation module adapted to compensate the user for viewing the particular advertisement variant.

19. The advertising system of claim 18, wherein:
the marketplace module is further adapted to associate incentives with particular demographic, psychographic, or behavioral user traits and to select a particular incentive for the particular user; and
the delivery module is further adapted to transmit the particular incentive to the particular user.

20. The advertising system of claim 18, wherein the delivery unit is adapted to transmit the particular advertisement to the particular user through a network of automated systems.
